(19) United States
(12) Patent Application Publication
(10) Pub. No.: US 2026/0218401 A1
(43) Pub. Date: Jul. 30, 2026

(54) HYBRID ELECTRODE COMPRISING PLASMONIC NANOPARTICLES AND ELECTROLYSIS SYSTEM COMPRISING THE SAME

(71) Applicant: POETICS HYDROGEN INC., Seoul (KR)

(72) Inventors: Dong Ha KIM, Seoul (KR); Jeongwon KIM, Seoul (KR)

(21) Appl. No.: 19/558,538

(22) Filed: Mar. 6, 2026

Related U.S. Application Data
(63) Continuation of application No. PCT/KR2024/013971, filed on Sep. 13, 2024.

(30) Foreign Application Priority Data
Sep. 15, 2023 (KR) 10-2023-0122855

(51) Int. Cl. C25B 11/091; C25B 9/17; C25B 9/50; C25B 11/052; H01M 4/86

(52) U.S. Cl. CPC C25B 11/091; C25B 9/17; C25B 9/50; C25B 11/052; H01M 4/8657

(57) ABSTRACT

The present disclosure relates to a hybrid electrode including plasmonic nanoparticles and an electrolysis system including the same. The hybrid electrode and the electrolysis system including the same according to embodiments of the present disclosure may utilize a plasmonic-active (antenna–reactor) composite electrode to re-activate a catalyst surface via plasmonic phenomena during an electrochemical reaction.

### DESCRIPTION

### CROSS-REFERENCE TO RELATED APPLICATIONS

This application is a continuation of PCT Application No. PCT/KR2024/013971, filed on September 13, 2024, which claims priority to Korean Patent Application Number 10-2023-0122855, filed on September 15, 2023, both of which are hereby incorporated by reference in their entirety.

### TECHNICAL FIELD

The present disclosure relates to a hybrid electrode including plasmonic nanoparticles and an electrolysis system including the same.

### BACKGROUND

Hydrogen is typically converted into a liquid hydrogen carrier in order to increase volumetric energy density for efficient transportation. This is because gaseous hydrogen has a low storage density, making it difficult to transport in large quantities. Accordingly, methods utilizing liquid hydrogen, ammonia, and liquid organic hydrogen carriers (LOHCs) as means for storing and transporting hydrogen have attracted attention. Particularly, hydrogen storage, transportation, and extraction methods using ammonia have attracted considerable attention. Ammonia provides a hydrogen storage capacity approximately 1.7 times higher than that of liquid hydrogen. Since ammonia is actively traded worldwide and related infrastructures, such as production facilities and transport vessels, are already well established, the use of ammonia as a hydrogen carrier can improve the economic efficiency in hydrogen supply.

Methods for producing hydrogen from ammonia may be broadly classified into thermal decomposition method, alkali metal amide method, and water electrolysis processes. In the thermal decomposition method, ammonia can be decomposed at a high temperature of 400°C or more and the use of a catalyst is essential. The alkali metal amide method can decompose ammonia at room temperature through an exothermic reaction with an alkali metal hydride, but has low economic efficiency. The water electrolysis method uses ammonia as an electrolyte and operates at a low temperature, and provides high stability and efficiency. However, conventional inventions relating to ammonia electrolysis have mainly focused on exploiting the activity of metal catalysts, such as the development of gold–platinum mixed catalysts, photocatalytic hydrogen production, and applications as electrochemical ammonia electrolysis catalysts.

### PRIOR ART DOCUMENT

Patent literature

Korean Registration Patent Gazette No. 2160870.

### DISCLOSURE OF THE INVENTION

### PROBLEMS TO BE SOLVED BY THE INVENTION

The present disclosure provides a hybrid electrode including plasmonic nanoparticles and an electrolysis system including the same.

However, problems to be solved by the present disclosure are not limited to the above-described problems, and although not described herein, other problems to be solved by the present disclosure can be clearly understood by those skilled in the art from the following descriptions.

### MEANS FOR SOLVING THE PROBLEMS

A first aspect of the present disclosure provides a hybrid electrode, including: a substrate; a catalyst layer formed on the substrate; and plasmonic nanoparticles formed on the catalyst layer, wherein electrons generated by plasmon excitation of the plasmonic nanoparticles are transferred to the catalyst layer.

A second aspect of the present disclosure provides an electrolysis system, including: a hybrid electrode including a substrate, a catalyst layer formed on the substrate, and plasmonic nanoparticles formed on the catalyst layer; a cathode electrode; and an electrolyte solution including a substance to be electrolyzed, wherein the hybrid electrode serves as an anode electrode at which an oxidation reaction of the substance to be electrolyzed occurs, and electrons generated by plasmon excitation of the plasmonic nanoparticles are transferred to the catalyst layer to desorb oxidation intermediates from the catalyst layer.

A third aspect of the present disclosure provides an electrolysis method, including: supplying power to the electrolysis system according to the second aspect and irradiating light; and obtaining H₂ at the cathode electrode.

A fourth aspect of the present disclosure provides a fuel cell, including: a hybrid electrode including a substrate, a catalyst layer formed on the substrate, and plasmonic nanoparticles formed on the catalyst layer; a cathode electrode; and an electrolyte layer, wherein the hybrid electrode serves as an anode electrode at which an oxidation reaction of a fuel occurs, and electrons generated by plasmon excitation of the plasmonic nanoparticles are transferred to the catalyst layer to desorb oxidation intermediates from the catalyst layer.

### EFFECTS OF THE INVENTION

A hybrid electrode and an electrolysis system including the same according to embodiments of the present disclosure may utilize a plasmonic-active (antenna–reactor) composite electrode to re-activate a catalyst surface via plasmonic phenomena during an electrochemical reaction.

In the electrolysis system according to embodiments of the present disclosure, electrons generated by plasmon excitation of plasmonic nanoparticles are transferred to a catalyst layer to desorb oxidation intermediates from the catalyst layer. Accordingly, it is possible to improve the activity and lifetime of the electrode.

### BRIEF DESCRIPTION OF THE DRAWINGS

FIG. 1A to FIG. 1 F illustrate, according to an example of the present disclosure: a schematic diagram of a synthesis process of an electrodeposited Pt (reactor)-Au (antenna) catalyst (FIG. 1A); XRD patterns of respective electrodes including a Ti fiber felt, Pt on the Ti felt, and Pt-Au on the Ti felt (FIG. 1B); SEM images of Pt on the Ti felt (FIG. 1C and FIG. 1D); and SEM images of Pt-Au on the Ti felt (FIG. 1E and FIG. 1F), wherein an inset of FIG. 1F shows atomic ratios of respective elements obtained from an SEM-EDS profile.

FIG. 2A(i)) to FIG. 2H illustrate, according to an example of the present disclosure, a schematic diagram of an electrolysis system (FIG. 2A(i)) and FIG. 2A(ii)); ex-situ XANES profiles and corresponding k³-weighted Fourier transforms (FTs) of Pt L₃-edge extended XAFS (EXAFS) spectra under ex-situ (FIG. 2B and FIG. 2C), in-situ (FIG. 2D and FIG. 2E), and operando conditions (FIG. 2G and FIG. 2H), wherein insets show enlarged pre-edge XANES regions; and a wavelet transform (WT) of k³-weighted EXAFS spectra at -0.2 V and -0.2 V under plasmonic excitation conditions (FIG. 2F).

FIG. 3A to FIG. 3 I illustrate, according to an example of the present disclosure, cyclic voltammetry (CV) profiles measured at a Pt-Au electrode in 1 M KOH and 0.5 M NH₄OH at room temperature using an H-type cell, with and without light irradiation (FIG. 3A); chronopotentiometry at a constant current density of 1 mA cm⁻² with and without light irradiation (FIG. 3B); CV profiles after short-term stability measurements (FIG. 3C); electrochemical double-layer capacitance (C_{dl}) (FIG. 3D); peak current densities with corresponding peak potentials for each electrode under dark and light-irradiated conditions (FIG. 3E); ECSA-normalized peak current densities for Pt and Pt-Au electrodes (FIG. 3F); specific activities at various applied potentials (FIG. 3G and FIG. 3H); and plasmonic enhancement of ammonia oxidation activity (FIG. 3I).

FIG. 4A to FIG. 4C illustrate, according to an example of the present disclosure, electrode surface temperatures at varying light irradiation intensities using an H-type cell (FIG. 4A); current density stability results of ammonia electrolysis under electrolyte temperature control only with and without light irradiation (FIG. 4B); and current density stability results of ammonia electrolysis at varying light irradiation intensities (FIG. 4C), wherein ammonia electrolysis was conducted under an operating condition of -0.2 V vs. Ag/AgCl.

FIG. 5A to FIG. 5D illustrate, according to an example of the present disclosure, results of analyzing electrochemical double-layer capacitance (C_{dl}) of an electrode surface using an H-type cell under conditions of no light irradiation (FIG. 5A), an elevated electrolyte temperature (FIG. 5B), and light irradiation (FIG. 5C); and calculated amounts of C_{dl} (FIG. 5D), indicating that the electrochemical surface area is highest under light irradiation conditions.

FIG. 6A to FIG. 6F illustrate, according to an example of the present disclosure, a continuous ammonia oxidation reaction (AOR) process at a constant potential of -0.2 V with respect to an Ag/AgCl reference electrode under dark, temperature-controlled, and plasmon excitation conditions (FIG. 6A); amounts of NH₃ reacted during the continuous AOR process under dark and light conditions (F IG. 6B); amounts of NH₃ reacted during the continuous AOR processes under light irradiation and redox AOR (FIG. 6C); cycling profiles (FIG. 6D(i), FIG. 6D(ii)); durability profiles including AOR kinetics and the total amount of reacted NH₃ (FIG. 6E); and differences and ratios between charges consumed for oxidation and reduction (Q_{Ox.} and Q_{Red.}) (FIG. 6F).

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

In the following description, exemplary embodiments of the present disclosure will be described in detail, but the present disclosure may not be limited thereto.

A first aspect of the present disclosure provides a hybrid electrode, including: a substrate; a catalyst layer formed on the substrate; and plasmonic nanoparticles formed on the catalyst layer, wherein electrons generated by plasmon excitation of the plasmonic nanoparticles are transferred to the catalyst layer.

In an embodiment of the present disclosure, the substrate may be any material used as an electrode substrate in the art without limitation. Non-limiting examples of the substrate may include carbon-based materials; metals including Ti, Ni, or Cu; inorganic oxides including oxides of Ti, Zr, Al, or Si; perovskite oxides; zeolites or combinations thereof.

In an embodiment of the present disclosure, the carbon-based materials may include one or more selected from the group consisting of graphite, carbon fiber, carbon sheet, carbon black, carbon nanotube (CNT), carbon sphere, carbon ribbon, fullerene, active carbon, carbon nanowire, and graphene, but is not limited thereto.

In an embodiment of the present disclosure, the substrate may have a structure including void spaces that permit passage of a fluid, but is not limited thereto.

In an embodiment of the present disclosure, the substrate may have a mesh structure, but is not limited thereto.

In an embodiment of the present disclosure, the substrate may have a mesh structure including Ti fiber, Ni fiber, or Pt fiber, but is not limited thereto.

In an embodiment of the present disclosure, the catalyst layer may include one or more selected from the group consisting of Pt, Pd, Ir, Ag, Ru, Ni, Cu, Mn, Co, Fe, and an alloy thereof, but is not limited thereto.

In an embodiment of the present disclosure, the plasmonic nanoparticles may include one or more selected from the group consisting of Au, Ag, Pt, Pd, Rh, Re, Cu, Al, Mg, In, Ga, Ni, and Rb, but may not be limited thereto.

In an embodiment of the present disclosure, the plasmonic nanoparticles may have a diameter distribution of about 5 nm to about 140 nm, and the number of plasmonic nanoparticles having a diameter of about 40 nm to about 90 nm may account for about 50% or more of the total number of the plasmonic nanoparticles.

In an embodiment of the present disclosure, the diameter of the plasmonic nanoparticles may be adjusted depending on light irradiation conditions (e.g., light wavelength range or type of light) during operation of the hybrid electrode and/or the type of the plasmonic nanoparticles. In an embodiment of the present disclosure, as a structural design capable of enhancing surface plasmonic efficiency under actual solar irradiation conditions (1 sun), the plasmonic nanoparticles may have an average diameter of about 60 nm to about 80 nm.

A second aspect of the present disclosure provides an electrolysis system, including: a hybrid electrode including a substrate, a catalyst layer formed on the substrate, and plasmonic nanoparticles formed on the catalyst layer; a cathode electrode; and an electrolyte solution including a substance to be electrolyzed, wherein the hybrid electrode serves as an anode electrode at which an oxidation reaction of the substance to be electrolyzed occurs, and electrons generated by plasmon excitation of the plasmonic nanoparticles are transferred to the catalyst layer to desorb oxidation intermediates from the catalyst layer.

Detailed descriptions of parts of the second aspect, which overlap with those of the first aspect, are omitted hereinafter, but the descriptions of the first aspect of the present disclosure may be identically applied to the second aspect of the present disclosure, even though they are omitted hereinafter.

In an embodiment of the present disclosure, the substance to be electrolyzed may include NH₃ or H₂O.

In an embodiment of the present disclosure, when the substance to be electrolyzed is NH₃, the electrolyte may include aqueous ammonia.

In an embodiment of the present disclosure, when the substance to be electrolyzed is NH₃, its concentration may be about 0.1 M to about 10 M, but may not be limited thereto. In an embodiment of the present disclosure, when the substance to be electrolyzed is NH₃, its concentration may be about 0.1 M to about 10 M, about 0.1 M to about 5 M, about 0.1 M to about 3 M, about 0.1 M to about 2 M, about 0.3 M to about 10 M, about 0.3 M to about 5 M, about 0.3 M to about 3 M, about 0.3 M to about 2 M, about 0.5 M to about 10 M, about 0.5 M to about 5 M, about 0.5 M to about 3 M, or about 0.5 M to about 2 M, but may not be limited thereto.

In an embodiment of the present disclosure, the electrolyte solution may further include an electrolyte including an alkali hydroxide.

In an embodiment of the present disclosure, the alkali hydroxide may include one or more selected from the group consisting of KOH, NaOH, and Ca(OH)₂, but may not be limited thereto.

In an embodiment of the present disclosure, the concentration of the alkali hydroxide may be about 0.1 M to about 10 M, but may not be limited thereto.

In an embodiment of the present disclosure, when the substance to be electrolyzed in the electrolysis system is NH₃, an ammonia oxidation reaction occurs at the anode electrode to form nitrogen gas and water, and a reduction reaction of water occurs at the cathode electrode to form hydrogen gas. In this case, reaction equations at the anode electrode and the cathode electrode are as follows:

Anode electrode : 2NH₃ + 6OH⁻ → N₂ + 6H₂O + 6e⁻

Cathode electrode : 6H₂O + 6e⁻ → 3H₂ + 6OH⁻

In an embodiment of the present disclosure, when the substance to be electrolyzed in the electrolysis system is NH₃, a poisoning phenomenon may occur in which continuous nitrogen oxide (NOₓ) intermediates are generated on the catalyst layer due to strong N bonding generated at the anode electrode. The nitrogen oxides may block an active catalytic surface, thereby causing a decrease in catalytic activity of the electrode. In the electrolysis system according to embodiments of the present disclosure, the electrons generated by plasmon excitation of the plasmonic nanoparticles are transferred to the catalyst layer and the nitrogen oxide intermediates from the catalyst layer are desorbed. Accordingly, it is possible to improve the activity and lifetime of the electrode.

In an embodiment of the present disclosure, the electrolysis system may further include a reference electrode. In an embodiment of the present disclosure, the reference electrode may include an Ag/AgCl (silver/silver chloride) electrode, but may not be limited thereto.

In an embodiment of the present disclosure, the electrolysis system may further include a separator membrane.

In an embodiment of the present disclosure, the electrolysis system may further include a separator membrane. Thus, the electrolysis system may be formed into a structure equipped with an anode electrode unit including the hybrid electrode, a cathode electrode unit including the cathode electrode, the separator membrane, a first electrolyte solution included in the anode electrode unit, and a second electrolyte solution included in the cathode electrode unit. Accordingly, it is possible to separately produce hydrogen gas and nitrogen gas.

In an embodiment of the present disclosure, the electrolysis system may further include a light irradiation unit.

In an embodiment of the present disclosure, light in a wavelength range of about 200 nm to about 2500 nm may be irradiated by the light irradiation unit.

In an embodiment of the present disclosure, the electrolysis system may further include a power supply unit.

A third aspect of the present disclosure provides an electrolysis method, including: supplying power to the electrolysis system according to the second aspect and irradiating light; and obtaining H₂ at the cathode electrode.

Detailed descriptions of parts of the third aspect, which overlap with those of the first aspect and the second aspect, are omitted hereinafter, but the descriptions of the first aspect and the second aspect of the present disclosure may be identically applied to the third aspect of the present disclosure, even though they are omitted hereinafter.

In an embodiment of the present disclosure, plasmonic phenomena (localized surface plasmon resonance, LSPR) of the plasmonic nanoparticles may occur by the light irradiation, and excited electrons generated by the plasmonic phenomena may desorb oxidation intermediates. Accordingly, it is possible to suppress a poisoning phenomenon.

In an embodiment of the present disclosure, the light irradiation may be performed within a wavelength range of about 200 nm to about 2500 nm.

A fourth aspect of the present disclosure provides a fuel cell, including: a hybrid electrode including a substrate, a catalyst layer formed on the substrate, and plasmonic nanoparticles formed on the catalyst layer; a cathode electrode; and an electrolyte layer, wherein the hybrid electrode serves as an anode electrode at which an oxidation reaction of a fuel occurs, and wherein electrons generated by plasmon excitation of the plasmonic nanoparticles are transferred to the catalyst layer to desorb oxidation intermediates from the catalyst layer.

Detailed descriptions of parts of the fourth aspect, which overlap with those of the first aspect to the third aspect, are omitted hereinafter, but the descriptions of the first aspect to third aspect of the present disclosure may be identically applied to the fourth aspect of the present disclosure, even though they are omitted hereinafter.

The fuel cell of the present disclosure may include, without limitation, any conventional fuel cells to which the technical features described herein can be applied.

In an embodiment of the present disclosure, the fuel cell may be a hydrogen fuel cell.

In an embodiment of the present disclosure, the fuel cell may be a polymer electrolyte membrane fuel cell (PEMFC). In general, when a fuel of a fuel cell contains carbon (C), such as natural gas, carbon monoxide (CO), which is an oxidation intermediate, may be generated during oxidation of the natural gas, and CO may be adsorbed onto a catalyst layer of an anode electrode, thereby causing a poisoning phenomenon that degrades fuel cell performance. In the fuel cell according to embodiments of the present disclosure, electrons generated by plasmon excitation of the plasmonic nanoparticles are transferred to the catalyst layer to desorb CO from the catalyst layer. Accordingly, it is possible to suppress a poisoning phenomenon.

Hereinafter, the present disclosure will be described in more detail with reference to Examples, but the present disclosure may not be limited thereto.

### MODE FOR CARRYING OUT THE INVENTION

### Example 1: Fabrication of Hybrid Electrode Including Plasmonic Antenna (Au) and Ammonia Oxidation Reactor (Pt)

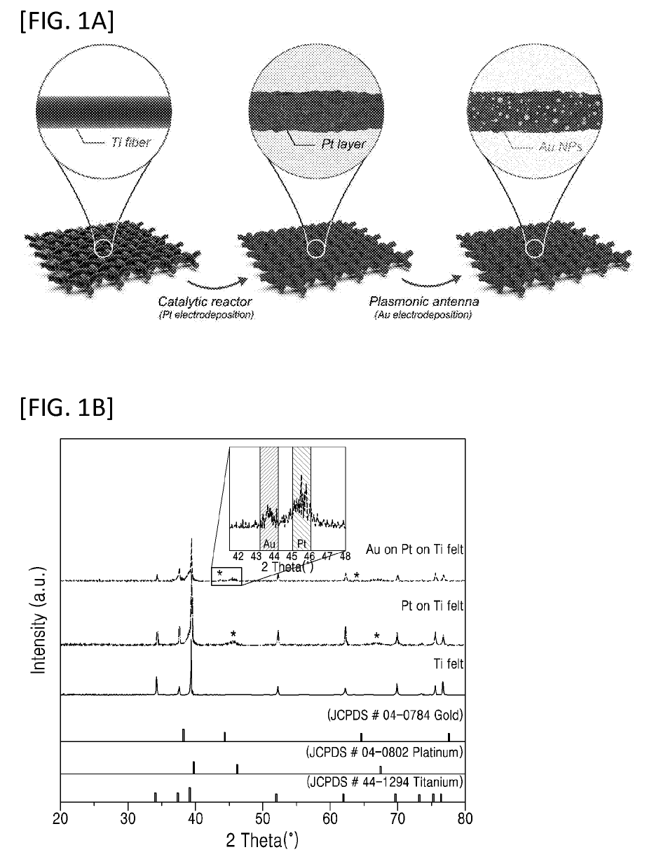

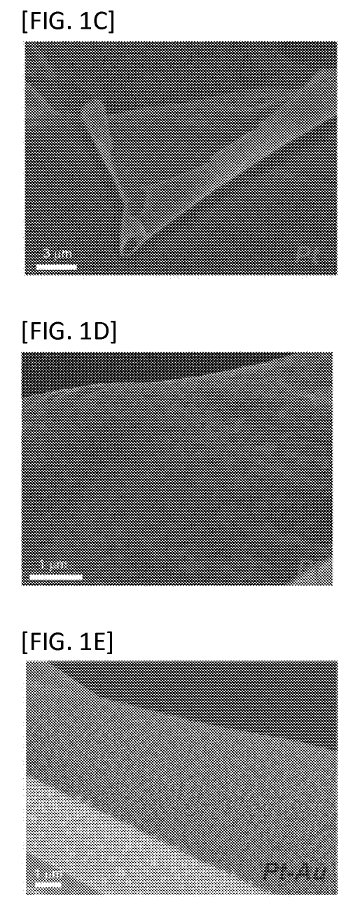

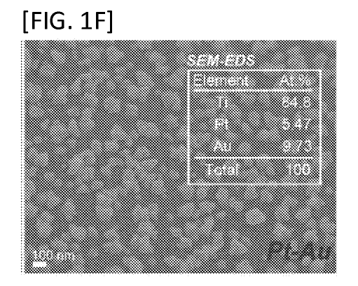

A mesh-structured substrate was prepared using Ti fibers. Thereafter, Pt was deposited on the Ti fibers by electrodeposition, followed by loading Au nanostructures. As a result, a hybrid electrode including a plasmonic antenna (Au) and an ammonia oxidation reactor (Pt) was fabricated (FIG. 1A).

The detailed procedure of Pt electrodeposition is as follow:

1) A batch-type three-electrode electrochemical system was configured.

- Ti electrode (working electrode)

- Ag/AgCl electrode (reference electrode)

- Graphite electrode (counter electrode)

2) The electrodes were immersed in a 5 mM H₂PtCl₆ electrolyte.

3) Pt was deposited by cyclic voltammetry in a potential range of −1.0 V to −0.2 V (vs. Ag/AgCl electrode) at a scan rate of 100 mV/s for 100 cycles.

The detailed procedure for depositing Au on Pt is as follows:

1) A batch-type three-electrode electrochemical system was configured.

Pt on Ti electrode (working electrode)

Ag/AgCl electrode (reference electrode)

Graphite electrode (counter electrode)

2) The electrodes were immersed in an electrolyte containing 1 mM HAuCl₄ and 0.05 M PBS.

3) Au was deposited by cyclic voltammetry in a potential range of −0.855 V to −0.055 V (vs. Ag/AgCl electrode) at a scan rate of 50 mV/s for 80 cycles.

Referring to FIG. 1B, it was confirmed that Pt and Au were deposited on the Ti substrate. Referring to FIG. 1C to FIG. 1F, Au nanoparticles have an average diameter of about 70 nm, with a diameter distribution ranging from a minimum of 5 nm to a maximum of 140 nm.

### Example 2: Fabrication of Ammonia Electrolysis System Including Hybrid Electrode

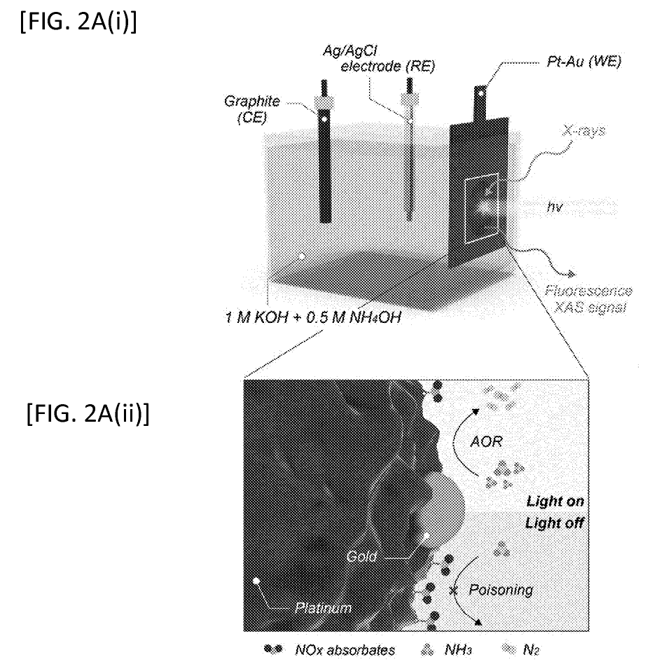

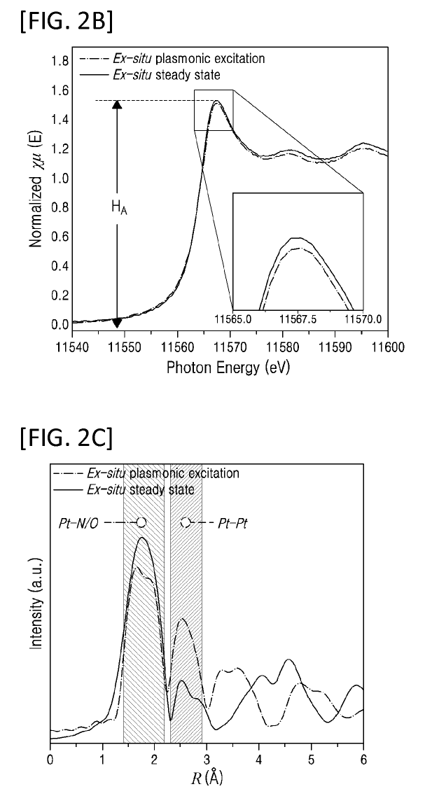

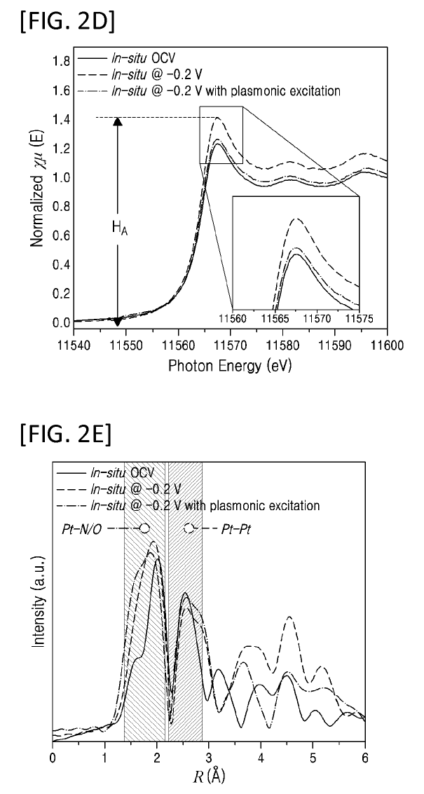

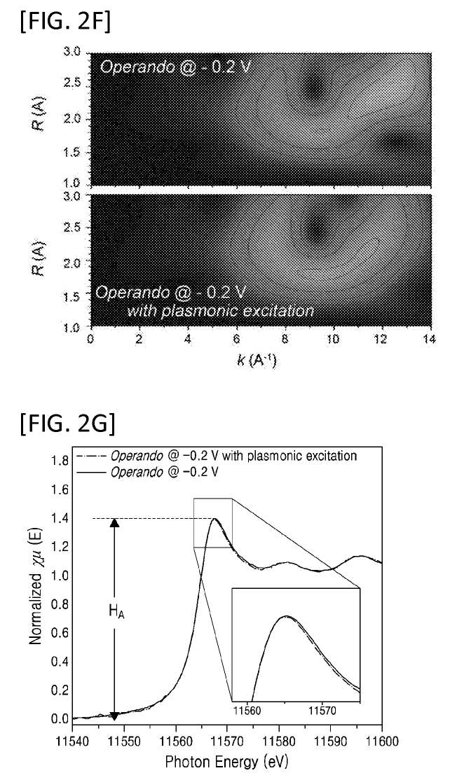

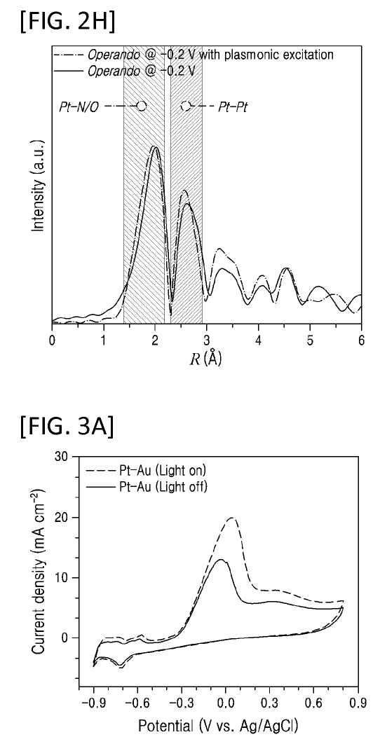

An ammonia electrolysis system was fabricated including the hybrid electrode fabricated in Example 1 as a working electrode, a graphite electrode as a counter electrode, an Ag/AgCl electrode as a reference electrode, and an electrolyte solution containing aqueous ammonia (FIG. 2A(i) AND FIG. 2A(ii)). The electrolysis system was fabricated using a PTFE (polytetrafluoroethylene) material that does not chemically react with the electrolyte. The electrolyte solution further contains 1 M KOH and 0.5 M NH₄OH. Also, light (1 sun) was irradiated onto the hybrid electrode to induce plasmonic activity of the hybrid electrode.

### Test Example

### 1. Electrochemical Analysis of Ammonia Electrolysis Reaction (Plasmonic Phenomenon)

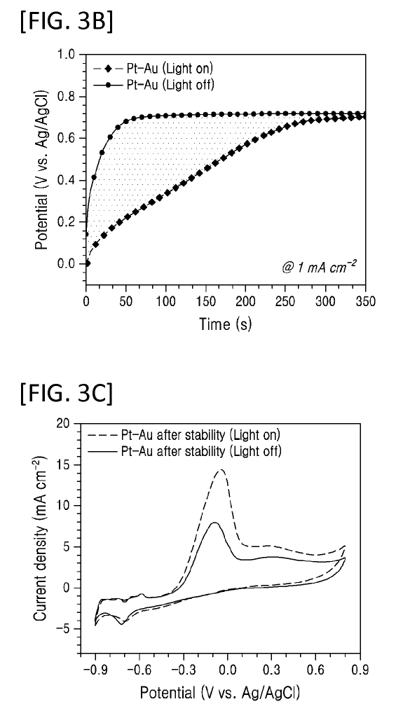

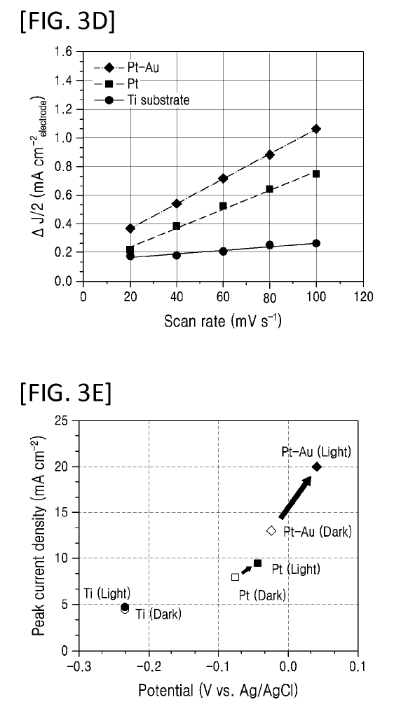

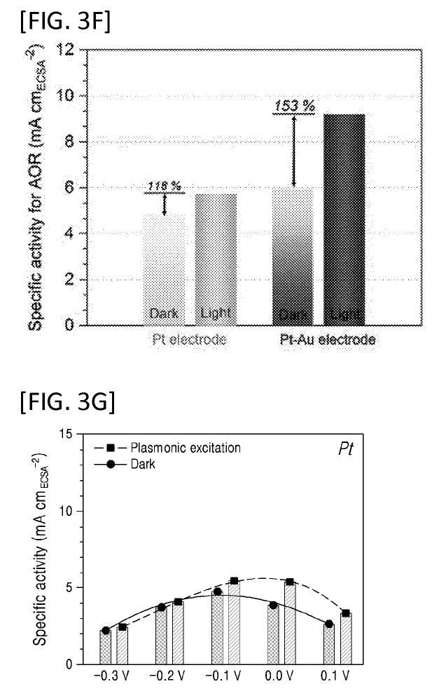

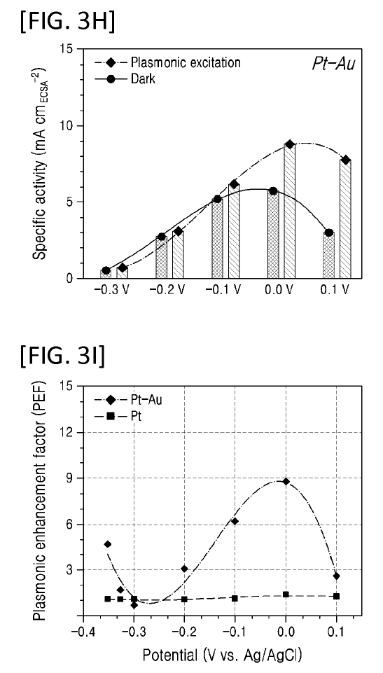

Electrochemical analysis of the ammonia electrolysis reaction was performed with and without light irradiation in the ammonia electrolysis system of Example 2. Referring to FIG. 3A to FIG. 3I, it was confirmed that the ammonia electrolysis reaction was enhanced before and after the plasmonic phenomenon. In the stability test shown in FIG. 3B, it was confirmed that the stability and efficiency were improved by the amount indicated by shaded area under a constant current condition (1 mA cm⁻²). In the cyclic voltammetry test shown in FIG. 3 C, it was confirmed that the enhancement in ammonia electrolysis performance resulting from the plasmonic phenomenon was maintained even after the electrode stability test. The cyclic voltammetry shown in in FIG. 3A and FIG. 3C was performed to measure electrochemical reactions within a scan range of −0.9 V to 0.8 V (vs. Ag/AgCl) at a scan rate of 20 mV s⁻¹. Further, referring to FIG. 3D to FIG. 3F, in the case of a simple Ti support or a Pt electrode prepared by electrodeposition, light irradiation induced only a negligible increase in electrochemical double-layer capacitance and ammonia electrolysis activity. However, the plasmonic phenomenon was observed only when Au nanoparticles were additionally loaded on the surface of the Pt electrode.

### 2. Verification of Plasmonic Phenomenon

### Verification of Plasmonic Phenomenon (Temperature Change)

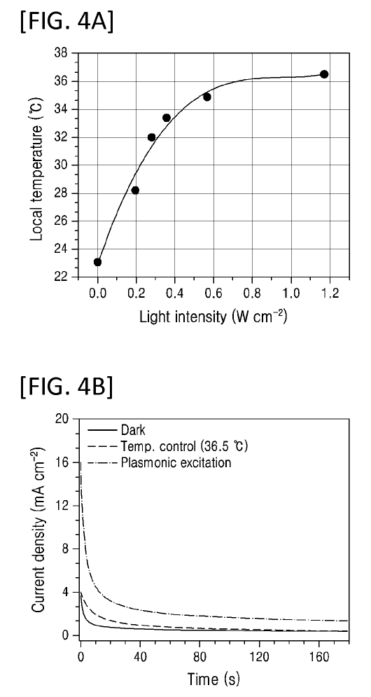

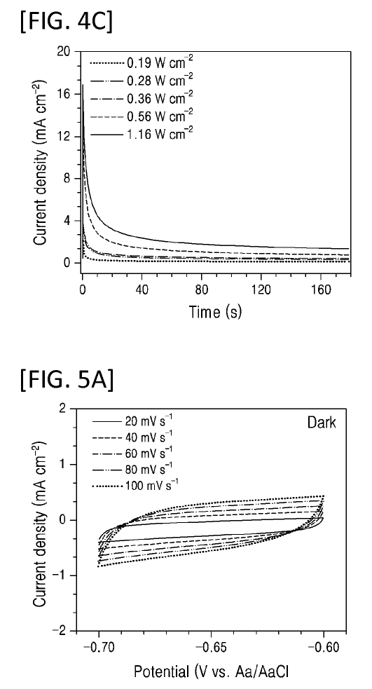

Upon induction of the plasmonic phenomenon, electrode surface temperature changes depending on light irradiation intensity were examined (FIG. 4A). Based on a comparison of stability tests between a condition in which only the electrolyte temperature was increased and a condition in which the plasmonic phenomenon was induced, the ammonia electrolysis system exhibited only a negligible change in stability when the electrolyte temperature alone was increased (FIG. 4B). It was confirmed that the ammonia electrolysis process resulted from the plasmonic phenomenon improved the reaction stability of the electrode (FIG. 4C). Accordingly, it was confirmed that an increase in electrode surface temperature caused by light irradiation was not a factor in improving ammonia electrolysis activity and stability, but electrons generated by the plasmonic phenomenon induced by light irradiation were responsible for the improvement in ammonia electrolysis activity and stability.

### Verification of Plasmonic Phenomenon (Electrochemical Surface Area)

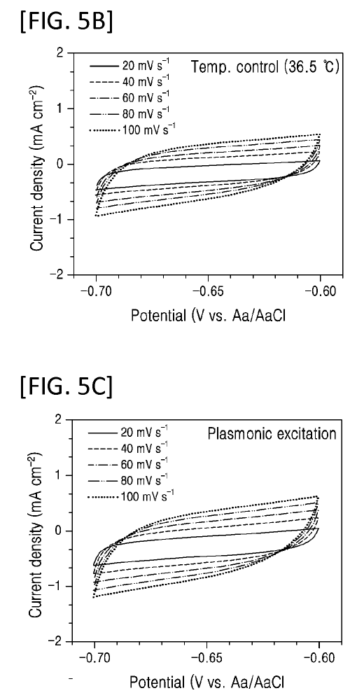

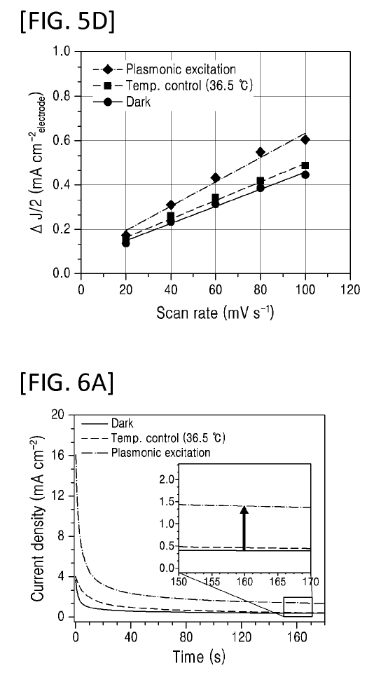

Upon induction of the plasmonic phenomenon, an increase in electrochemical surface area and active sites of the electrode was observed (FIG. 5A to FIG. 5D). In the electrode for which only the electrolyte temperature was increased, no change in electrochemical surface area was observed. Accordingly, it was confirmed that the increased ammonia electrolysis activity and stability upon induction of the plasmonic phenomenon resulted from enhanced interactions between the electrode and the electrolyte due to an increase in electrochemical double-layer capacitance.

### 3. Surface Analysis of Ammonia Electrolysis Reaction (Verification of Surface Reactivation)

It was confirmed through real-time and static surface analysis that Pt-N bonds on the hybrid electrode decreased upon induction of the plasmonic phenomenon during ammonia electrolysis (FIG. 2B to FIG. 2H). Accordingly, it was confirmed that the plasmonic phenomenon directly functions to restore active sites of the Pt electrode. Changes in the oxidation state of Pt metal before and after the plasmonic phenomenon were identified through FIG. 2B, FIG. 2D, and FIG. 2G, and surface bonding of Pt metal before and after the plasmonic phenomenon was confirmed through FIG. 2C, FIG. 2E, and FIG. 2H. In particular, as confirmed from the results of FIG. 2D and FIG. 2E, Pt-N bonds generated during ammonia electrolysis decreased after the plasmonic phenomenon (light irradiation), thereby reconfirming that the improvement in ammonia electrolysis activity and stability due to the plasmonic phenomenon resulted from suppression of surface Pt-N (poisoning phenomenon). As confirmed from the results of FIG. 2F, the degree of change on the Pt surface before and after the plasmonic phenomenon was visually identified.

### 4. Optimization of Plasmonics-Based Ammonia Electrolysis Process (Plasmonics + Electrochemistry)

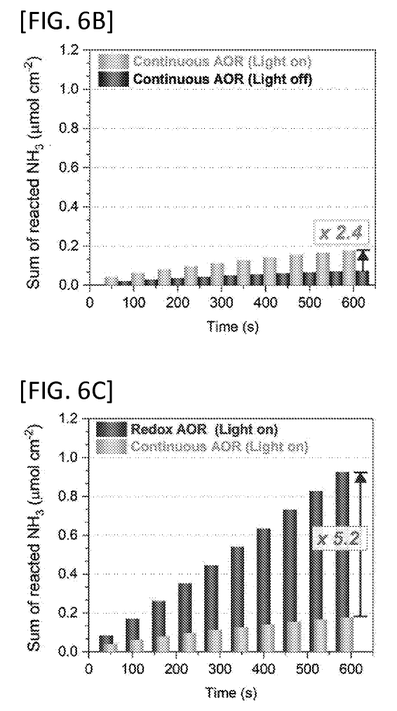

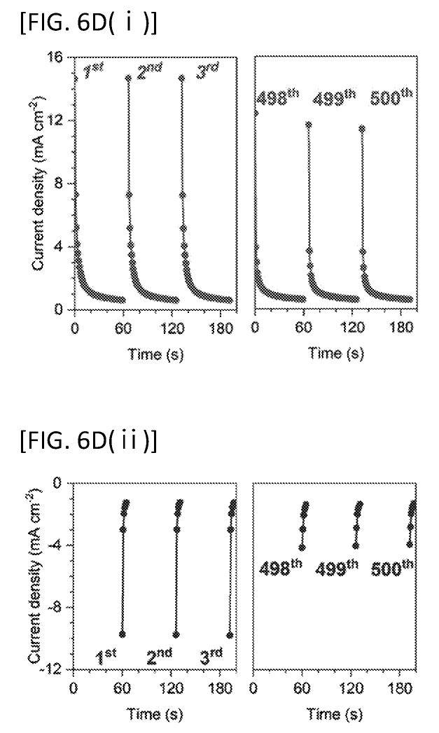

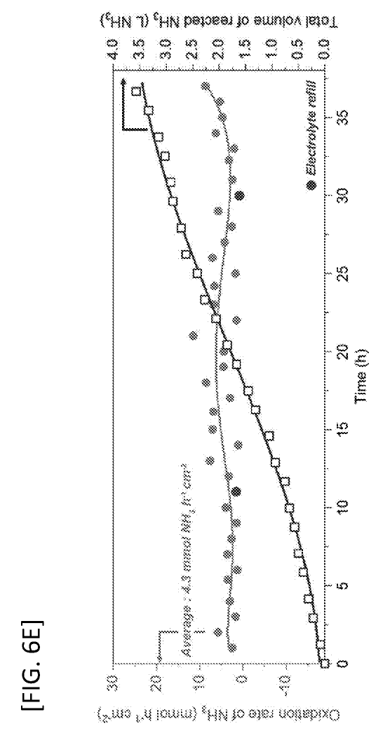

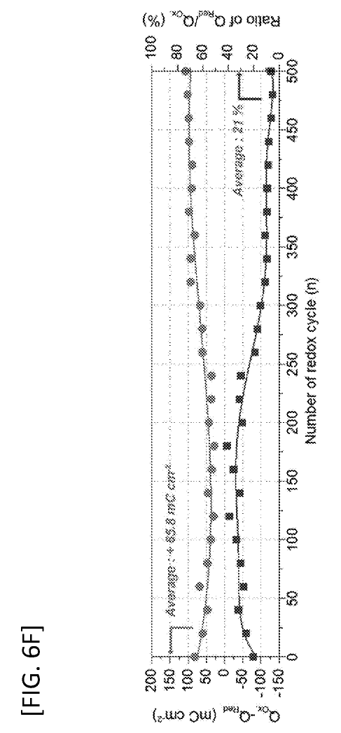

It was confirmed that applying a plasmonics-based oxidation/reduction protocol increased the amount of electrolyzed ammonia by about 12-fold over the same period compared to simple ammonia electrolysis (FIG. 6A to FIG. 6F). In FIG. 6A, ammonia electrolysis stability was increased under plasmonic conditions and constant current conditions. Furthermore, it was confirmed that applying a protocol including plasmonics-based oxidation (−0.2 V vs. Ag/AgCl, 60 s) and reduction (−0.8 V vs. Ag/AgCl, 6 s) enhanced ammonia electrolysis stability by about 12-fold compared to the ammonia electrolysis stability under constant current conditions (FIG. 6C). Accordingly, stable oxidation-reduction activity was confirmed for up to about 500 cycles during the application of the oxidation-reduction protocol (FIG. 6D(i), FIG. 6D(ii)). As a result, according to a plasmonics-based ammonia electrolysis protocol, the ammonia electrolysis process was performed stably for about 40 hours at an electrolysis rate of 4.3 mmol NH₃ h⁻¹ cm⁻².

The above description of the present disclosure is provided for the purpose of illustration, and it would be understood by those skilled in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A hybrid electrode, comprising:
a substrate;
a catalyst layer formed on the substrate; and
plasmonic nanoparticles formed on the catalyst layer,
wherein electrons generated by plasmon excitation of the plasmonic nanoparticles are transferred to the catalyst layer.

2. The hybrid electrode of claim 1,
wherein the substrate has a structure including void spaces that permit passage of a fluid.

3. The hybrid electrode of claim 1,
wherein the catalyst layer includes one or more selected from the group consisting of Pt, Pd, Ir, Ag, Ru, Ni, Cu, Mn, Co, Fe, and an alloy thereof.

4. The hybrid electrode of claim 1,
wherein the plasmonic nanoparticles include one or more selected from the group consisting of Au, Ag, Pt, Pd, Rh, Re, Cu, Al, Mg, In, Ga, Ni, and Rb.

5. The hybrid electrode of claim 1,
wherein the plasmonic nanoparticles have a diameter distribution of 5 nm to 140 nm, and
wherein the number of plasmonic nanoparticles having a diameter of 40 nm to 90 nm accounts for 50% or more of the total number of the plasmonic nanoparticles.

6. The hybrid electrode of claim 1,
wherein the plasmonic nanoparticles have an average diameter of 60 nm to 80 nm.

7. An electrolysis system, comprising:
a hybrid electrode including a substrate, a catalyst layer formed on the substrate, and plasmonic nanoparticles formed on the catalyst layer; a cathode electrode; and an electrolyte solution including a substance to be electrolyzed,
wherein the hybrid electrode serves as an anode electrode at which an oxidation reaction of the substance to be electrolyzed occurs, and
electrons generated by plasmon excitation of the plasmonic nanoparticles are transferred to the catalyst layer to desorb oxidation intermediates from the catalyst layer.

8. The electrolysis system of claim 7,
wherein the substance to be electrolyzed includes NH₃ or H₂O.

9. The electrolysis system of claim 7,
wherein when the substance to be electrolyzed is NH₃, its concentration is 0.1 M to 10 M.

10. The electrolysis system of claim 7,
wherein the electrolyte solution further includes an electrolyte including an alkali hydroxide.

11. The electrolysis system of claim 7, further comprising:
a light irradiation unit.

12. The electrolysis system of claim 7, further comprising:
a power supply unit.

13. A fuel cell, comprising:
a hybrid electrode including a substrate, a catalyst layer formed on the substrate, and plasmonic nanoparticles formed on the catalyst layer; a cathode electrode; and an electrolyte layer,
wherein the hybrid electrode serves as an anode electrode at which an oxidation reaction of a fuel occurs, and
wherein electrons generated by plasmon excitation of the plasmonic nanoparticles are transferred to the catalyst layer to desorb oxidation intermediates from the catalyst layer.

14. The fuel cell of claim 13,
wherein the fuel cell is a hydrogen fuel cell.
